(19) United States
(12) Patent Application Publication
(10) Pub. No.: US 2014/0113264 A1
(43) Pub. Date: Apr. 24, 2014

(54) EMOTION EXCHANGE APPARATUS AND METHOD FOR PROVIDING THEREOF

(71) Applicant: Ji Hyun MOON, Seoul (KR)

(72) Inventor: Ji Hyun MOON, Seoul (KR)

(21) Appl. No.: 13/888,994

(22) Filed: May 7, 2013

(30) Foreign Application Priority Data
Oct. 23, 2012 (KR) 10-2012-0118111

(51) Int. Cl. G09B 5/06

(52) U.S. Cl. CPC G09B 5/06
USPC 434/308

(57) ABSTRACT

An emotion exchange apparatus comprises: a communication unit configured to receive an emotion signal of an emotion deliverer from an external device; an output unit configured to output the emotion signal; an input unit configured to receive a counterpart emotion signal of an emotion learner in response to the emotion signal; and a controller coupled to one or more of the output unit, the input unit, and the communication unit, and configured to receive the emotion signal from the external device through the communication unit, output the emotion signal in an audible or visual manner, receive the counterpart emotion signal from the input unit, and transmit the counterpart emotion signal to the external device through the communication unit.

### CROSS-REFERENCE TO RELATED APPLICATION

This application claims priority to and the benefit of Korean Patent Application No. 2012-0118111, filed on Oct. 23, 2012, the disclosure of which is incorporated herein by reference in its entirety.

### BACKGROUND

1. Field of the Invention

The present invention relates to an emotion exchange providing apparatus and method, and more particularly, to an emotion exchange apparatus for helping a child to express emotions while assisting with continual emotion exchange of parents.

2. Discussion of Related Art

Emotion education for children represents activities of allowing children to precisely recognize what they feel. Through emotion education, children can find a way to deal with their emotions. Small children may not recognize what their feelings represent. Further, they may come upon cases in which they do not know a way to express their feelings. Accordingly, children express their feelings as so-called ‘irritation’ when they are sad, angry, or anxious. Children need to learn about emotions while growing up. Natural learning of emotion is possible, but in recent years, it has been proved that a learning of emotions through education is effective.

In general, a doll is used for emotion education. A method using a doll allows children to express their emotions while playing with and touching a character doll.

Emotion education through a doll has an advantage of teaching respective emotions to children, but such a method has a limitation in that an educator or a parent, a child, and a doll need to be present in one space and the experience with the emotion education is fragmentary rather than continual.

In addition, along with the increasing trend double-income households, parents are finding it difficult not only to provide proper emotion education to their children but also to have emotional exchanges such as singing nursery songs or reading fairy tales.

Meanwhile, a dialog robot or a learning robot for child education has been developed, but such a robot performs no more than a signal exchange between a child and a robot. In addition, such a learning robot is not helpful for sympathy between a child and parent, and the education is one-way education such as playing a video, thereby resulting in a limitation on the effective emotion education.

### SUMMARY OF THE INVENTION

The present invention is directed to an emotion exchange apparatus that can help children with emotion learning while providing parents or an educator with continual emotion exchange with children.

The present invention is also directed to an emotion exchange apparatus that can provide parents or an educator with emotion exchange with children even if an emotion deliverer and an emotion learner are not present in one space, and a method thereof.

A first aspect of the invention is an emotion exchange apparatus comprising:

a communication unit configured to receive an emotion signal of an emotion deliverer from an external device; an output unit configured to output the emotion signal; an input unit configured to receive a counterpart emotion signal of an emotion learner in response to the emotion signal; and a controller coupled to one or more of the output unit, the input unit, and the communication unit, and configured to receive the emotion signal from the external device through the communication unit, output the emotion signal in an audible or visual manner, receive the counterpart emotion signal from the input unit, and transmit the counterpart emotion signal to the external device through the communication unit.

In another embodiment, the controller indicates reception of the emotion signal through the output unit.

In another embodiment, the emotion signal comprises a voice and information related to the voice, and the output unit simultaneously outputs the voice and the information related to the voice.

In another embodiment, the information related to the voice is a fairy tale, a nursery song, or information related to delivering emotion.

In another embodiment, the controller outputs the emotion signal or the counterpart emotion signal in an arrangement form according to a predetermined scheme.

In another embodiment, the controller receives data related to a human body from an external sensor, and transmits the data related to the human body to the external device through the communication unit.

In another embodiment, the counterpart emotion signal is generated by selecting one of a plurality of emotion representations on the input unit.

In another embodiment, the counterpart emotion signal comprises information related to an emotion representation or at least one portion of the emotion signal.

In another embodiment, the input unit comprises at least one of buttons, a touch panel, a joystick, a microphone, a camera, a keyboard, and a mouse.

A second aspect of the invention is a method of providing emotion exchange, the method comprising: receiving an emotion signal comprising at least a voice and information related to the voice from an external device; transmitting the emotion signal to an emotion exchange apparatus; receiving a counterpart emotion signal generated from the emotion exchange apparatus; storing the counterpart emotion signal in a storage according to time periods; and transmitting the counterpart emotion signal stored according to time periods to the external device or the emotion exchange apparatus.

In another embodiment, the information related to the voice is a fairy tale, a nursery song, or information related to delivering emotion.

In another embodiment, a method further comprises receiving data related to a human body from the emotion exchange apparatus, and transmitting the data related to the human body to the external device.

In another embodiment, the counterpart emotion signal is generated by selecting one of a plurality of emotion representations on the emotion exchange apparatus.

A third aspect of the invention is a method of exchanging emotion through an emotion exchange apparatus, the method comprising: receiving an emotion signal from an emotion deliverer; receiving a counterpart emotion signal from an emotion learner; and generating a series of signals by storing the emotion signal and the counterpart emotion signal in a sequential order or a predetermined order.

In another embodiment, the emotion signal is a fairy tale, a nursery song, or information related to delivering emotion.

In another embodiment, the emotion signal or the counterpart emotion signal is generated by selecting one of a plurality of emotion representations on the emotion exchange apparatus.

However, the problems to be solved according to the present invention are not limited to the above-described problems, and other problems which are not disclosed herein may be made apparent to those skilled in the art by the detailed description provided below.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is a conceptual diagram illustrating an emotion exchange apparatus management system according to an exemplary embodiment of the present invention;

FIG. 2 is a block diagram illustrating an emotion exchange apparatus according to an exemplary embodiment of the present invention;

FIG. 3 is a flowchart showing an emotion exchange method according to an exemplary embodiment of the present invention;

FIG. 4 is a schematic view illustrating the configuration of the emotion exchange apparatus according to an exemplary embodiment of the present invention and a sensor communicating with the emotion exchange apparatus;

FIG. 5 is a view illustrating a schematic user interface (UI) of an external device associated with the emotion exchange apparatus according to an exemplary embodiment of the present invention;

FIG. 6 is a view illustrating a schematic user interface (UI) related to continual storytelling by the emotion exchange apparatus according to an exemplary embodiment of the present invention;

FIG. 7 is a schematic view illustrating a series of signals related to continual storytelling according to an exemplary embodiment of the present invention;

FIG. 8 is a flowchart showing an emotion exchange method at a system server end according to an exemplary embodiment of the present invention; and

FIG. 9 is a flowchart showing an emotion exchange method according to another exemplary embodiment of the present invention.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

A combination of blocks in an accompanying block diagram and a combination of operations in a flowchart may be performed by algorithms or computer program instructions which are composed of a firmware, software, or hardware. Since the algorithms or the computer program instructions may be installed on general-purpose computers, special-purpose computers, or processors of the other programmable digital signal processing devices, the instructions executed through the computers or the processors of the other programmable data processing equipment serve to create functions described in each of the blocks in the block diagram or each of the operations in the flowchart. The algorithms or the computer program instructions may be stored in computer-usable or computer-readable memories which intend to be used for the computer or the other programmable data processing equipment so as to realize the functions using a certain method. Therefore, the instructions stored in the computer-usable or computer-readable memories may be used to produce a manufacturing article including an instruction tool for executing the functions described in each of the blocks in the block diagram or each of the operations in the flowchart. Since the computer program instructions may be installed onto the computers or the other programmable data processing equipment, a series of motion operations may be performed on the computers or the other programmable data processing equipment to create processes executed on the computers. As a result, the instructions used to execute the computers or the other programmable data processing equipment can provide operations for executing the functions described in each of the blocks in the block diagram or each of the operations in the flowchart.

Also, a part of a module, a segment, or a code including one or more practicable instructions for executing a certain logical function(s) may be shown in each of the blocks or the operations.

In some alternative embodiments, it should also be noted that the functions described in each of the blocks or the operations may be exhibited out of sequence. For example, two blocks or operations shown in sequence may be executed substantially at the same time, or be often executed in a reverse sequence according to the corresponding functions.

Although the terms first, second, etc. may be used to describe various elements, it should be understood that these elements are not limited by these terms. These terms are only used to distinguish one element from another. For example, a first element could be termed a second element, and, similarly, a second element could be termed a first element, without departing from the scope of exemplary embodiments.

In this specification, when one element “transmits” data or signals to another element, one element can transmit data or signals to another element directly or one element can transmit data or signals to another element via at least one other element.

Hereinafter, various exemplary embodiments of the present invention will be described in further detail with reference to the accompanying drawings.

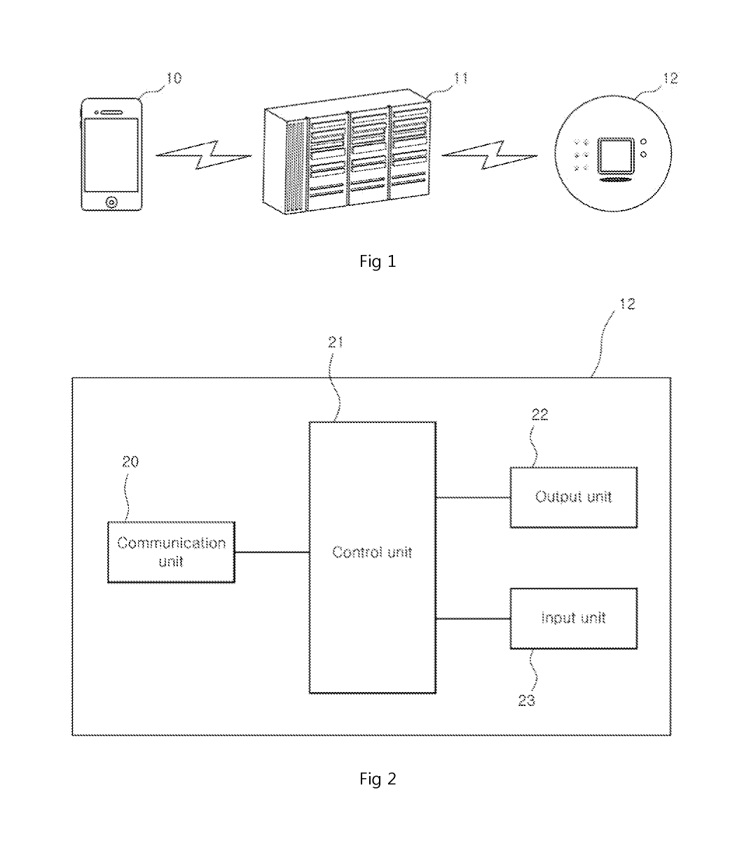

FIG. 1 is a conceptual diagram illustrating an emotion exchange apparatus management system according to an exemplary embodiment of the present invention. Referring to FIG. 1, an emotion exchange apparatus management system 100 may include an external device 10, a system server 11, and an emotion exchange apparatus 12.

The emotion exchange apparatus management system 100 represents a system for exchanging emotion between a user of the external device 10 and a user of the emotion exchange apparatus 12 by transmitting an emotion signal, a counterpart emotion signal, or a combination thereof between the external device 10 and the emotion exchange apparatus 12.

In the description of the present invention, an ‘emotion signal’ represents a signal related to all emotions transmitted to a child from parents, an educator, or a doctor. In the description of the present invention, the emotion signal is a signal transmitted from the external device 10 to the emotion exchange apparatus 12. The emotion signal may include various types of voices such as a nursery song, an effect sound, and a bedtime story, and information related to such a voice message may include lyrics of a nursery song, background sound, a still image, a moving image, and animation. In addition, the emotion signal may include both a voice and information related to the voice.

In the description of the present invention, a ‘counterpart emotion signal’ represents a signal related to all emotions being transmitted by a child to parents, an educator, or a doctor. In the description of the present invention, the counterpart emotion signal is a signal being transmitted from the emotion exchange apparatus 12 to the external device 10. The counterpart emotion signal may include a voice, a moving image, or an emotion representation generated by selecting one of a plurality of emotion representations. The emotion representation generated by selecting one of the plurality of emotion representations will be described later in detail in conjunction with the description of the emotion exchange apparatus 12.

The external device 10 may include at least a microprocessor, a memory, and a communication module, for example, the external device 10 may be a terminal or a portable terminal. In a case in which the external device 10 is a portable terminal, the portable terminal may be a cellular phone, a smartphone, a notebook computer, a digital broadcasting terminal, a personal digital assistant (PDA), a portable multimedia player (PMP), a navigation system, or accessories used in combination thereof.

In addition, the external device 10 may be a terminal additionally produced for exclusive use of the emotion exchange apparatus or accessories used in combination thereof rather than the existing terminals as described above. Even when a terminal produced for exclusive use of the emotion exchange apparatus is implemented as the external device 10, the terminal may include all elements of the external device 10 that is to be described below, and the terminal may have a design that is compact when compared to other external devices and associated with the emotion exchange apparatus. However, the terminal produced for exclusive use of the emotion exchange apparatus may only include a synchronization function and a playback function. The transmission/reception, synchronization, and playback of the terminal will be described later.

Hereinafter, for convenience of description, a case in which the external device 10 is a smartphone will be described as an exemplary embodiment. For convenience of description, the emotion exchange apparatus management system 100 will be illustrated as having a single external device 10, but the present invention is not limited thereto. The emotion exchange apparatus management system 100 may include a plurality of external terminals 10 by having a plurality of emotion deliverers adopted thereto.

The system server 11 manages various types of information related to operating the emotion exchange apparatus management system 100, user registration, and authentication information to authenticate the external device 10 or the emotion exchange apparatus 12. The authentication information may be managed through a different configuration of a system server according to another exemplary embodiment of the present invention. The emotion exchange apparatus management system 100 registers or authenticates the external device 10 or the emotion exchange apparatus 12 through the system server 11. That is, the system server 11 receives an emotion signal or information from the external device 10, authenticates the received signal or information, searches for the emotion exchange apparatus 12 that is set, and transmits the emotion signal or information to the found emotion exchange apparatus 12. On the other hand, the system server 11 receives a counterpart emotion signal from the emotion exchange apparatus 12, authenticates the received counterpart emotion signal, searches for the external device 10 that is set, and transmits the counterpart emotion signal to the found external device 10.

Although an authentication operation between the external device 10 and the emotion exchange apparatus 12 through the system server 11 may be applied to all the transmission/reception operations that are to be described below, the description of the authentication operation will be omitted for the sake of convenience.

The system server 11 provides data and related programs required to use the emotion exchange apparatus management system 100. The data and related programs required to use the system 100 may include webpages, smartphone applications, and customized programs.

The system server 11 manages the emotion signals or the counterpart emotion signals being transmitted and received, and provides the emotion signals or the counterpart emotion signals to the external device 10 or the emotion exchange apparatus 12. The system server 11 stores the emotion signals and the counterpart emotion signals in a sequential order or a predetermined order to generate a series of signals, or stores the emotion signals and the counterpart emotion signals according to time periods to provide the stored emotion signals and the counterpart emotion signals to the external device 10 or the emotion exchange apparatus 12. A detailed configuration thereof will be described later.

The system server 11 includes a database in which system information of the emotion exchange apparatus management system 100, the emotion signal, the counterpart emotion signal, related program information, and a series of signals stored in a sequential order or a predetermined order are provided and managed.

The emotion exchange apparatus 12 is an apparatus configured to provide emotion exchange and emotion education to children using the emotion exchange apparatus 12 by transmitting and receiving the emotion signal and the counterpart emotion signal with respect to the external device 10. The emotion exchange apparatus 12 may have a toy or a doll as a body thereof. The emotion exchange apparatus 12 includes a communication unit, an output unit, an input unit, and a controller, and communicates through a communication network. A detailed configuration of the emotion exchange apparatus 12 will be described later.

The communication between the external device 10 and the system server 11, the communication between the system server 11 and the emotion exchange apparatus 12, or the communication between the external device 10 and the emotion exchange apparatus 12 may be performed through a communication network in a wireless scheme. The communication network may be a high-speed backbone network of a large-scale communication network capable of a large capacity, long distance voice and data service, and a next generation wired/wireless network capable of providing the Internet or a high-speed multimedia service. In a case in which the communication network is a mobile communication network, the mobile communication network may be a synchronous mobile communication network or an asynchronous mobile communication network. As an example of the asynchronous mobile communication network, a Wideband Code Division Multiple Access (WCDMA) scheme communication network may be used. When the WCDMA scheme is used, although not shown in the drawings, the mobile communication network may include a radio network controller (RNC). Although the WCDMA network is described as an example of the communication network, the communication network according to the present invention may be a next generation communication network, such as a 3G network, an LTE network, and a 4G network, or another IP-based network.

The communication network may be Bluetooth using IEEE 802.15.1 standard. Alternatively, the communication network may be a wireless local area network (WLAN). The WLAN is technology allowing access to the Internet in a wireless scheme in a home or business or a certain servicing area using the external device 10 such as a laptop computer, a navigation device, and a smartphone based on radio frequency technologies.

FIG. 2 is a block diagram illustrating the emotion exchange apparatus 12 according to an exemplary embodiment of the present invention. Referring to FIG. 2, the emotion exchange apparatus 12 includes a communication unit 20, a controller 21, an output unit 22, and an input unit 23.

The communication unit 20 includes a wireless communication unit, and using the wireless communication unit, receives an emotion signal transmitted by the external device 10 through the server. For example, in a case in which the communication unit 20 performs a communication using a wireless communication unit, the external device 10 may also be configured to use a wireless communication unit. The expression exchange apparatus 12 may receive an emotion signal through the system server 11 using the communication network such as the 3G network and the 4G network, the WLAN communication network, or the local area network, such as a Bluetooth connection. In addition, the counterpart emotion signal may be transmitted in the same manner as the above.

The output unit 22 outputs the emotion signal received from the external device 10 through a voice or in a visual manner. The output unit 22 may include a speaker outputting a voice and a display apparatus. In addition, the output unit 22 may indicate various types of information related to the emotion exchange apparatus 12. For example, the output unit 22 may notify that an emotion signal is received from the external device 10, in the form of an effect sound or a voice. In this case, the voice may be a voice related to an emotion deliverer delivering the emotion signal. In a case in which the sound notifying of the reception of the emotion signal is related to the emotion deliverer, more intimate emotion exchange is possible.

The input unit 23 generates a counterpart emotion signal from the emotion exchange apparatus 12 in response to the emotion signal. The input unit 23 may include at least one of buttons, keys, a touch panel, a joystick, a microphone, a camera, a keyboard, and a mouse. Various types of input devices may be applied to the input unit other than those described above. The counterpart emotion signal may be generated by selecting one of a plurality of emotion representations. The detailed configuration and method of generating the counterpart emotion signal will be described later.

The controller 21 is coupled to one or more of the communication unit 20, the output unit 22, and the input unit 23, receives the emotion signal from the external device 10 through the communication unit 20, audibly or visually outputs the received emotion signal, receives the counterpart emotion signal from the input unit 23, and transmits the received counterpart emotion signal to the external device 10 through the communication unit 20.

In addition, the controller 21 is configured to manage the authentication and registration of the emotion exchange apparatus 12 as described above in relation to the system server 11. The emotion exchange apparatus 12 has a unique authentication number, is authenticated through the authentication number, and performs transmission/reception only with a registered external device 10.

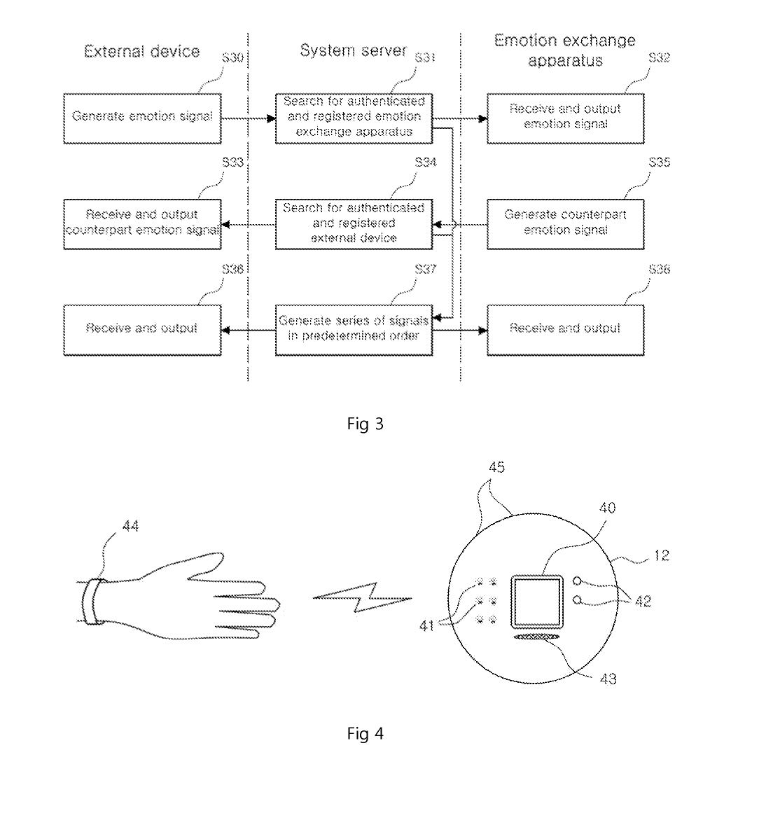

FIG. 3 is a flowchart showing an emotion exchange method according to an exemplary embodiment of the present invention.

First, an emotion signal is generated from the external device 10 (S30). According to an exemplary embodiment of the present invention, the emotion signal includes a voice and information related to the voice. For example, the emotion signal may be a nursery song voice recorded by an emotion deliverer, an accompaniment sound of a nursery song, and an image related to a nursery song. Further, the emotion signal may include a bedtime story or a fairy tale voice recorded by an emotion deliverer. The bedtime story represents a fairy tale read by parents before children fall asleep. The emotion signal may further include an image related to the bedtime story or fairy tale voice. Alternatively, the emotion signal may include other signals in addition to the emotion-related signals described above.

The system server 11 authenticates the external device 10, receives the emotion signal from the external device 10, searches for the emotion exchange apparatus 12 that is registered, and transmits the emotion signal to the found emotion exchange apparatus 12 (S31). Through such an operation, the external device 10 transmits the generated emotion signal to the emotion exchange apparatus 12. Meanwhile, the system server 11 separately stores the emotion signal.

The emotion exchange apparatus 12 receives the emotion signal and outputs the received emotion signal (S32). Thereafter, a counterpart emotion signal is generated from the emotion exchange apparatus 12 (S33). According to an exemplary embodiment of the present disclosure, the counterpart emotion signal may include various signals representing emotions. Herein, the emotion represents all the states of mind that are felt by a human, such as happiness, joy, surprise, inspiration, sadness, and anger. The counterpart emotion signal is generated by selecting one of a plurality of emotion representations. For example, a plurality of buttons are configured to correspond to the plurality of emotions, and by selecting one button, an emotion corresponding to the button is selected. In addition, one of the plurality of emotion representations may be selected by a joystick, or may be selected by touching an image, which is related to an emotion, being represented on a touch screen. Through this, a user of the emotion exchange apparatus 12 represents his or her emotion in response to the emotion signal and compares his or her own emotion with the represented emotion image, thereby recognizing the type of emotion.

The counterpart emotion signal may additionally include a voice recorded through a microphone, information related to the voice, an image captured by a camera or a moving image in addition to the signal representing emotions. The additional counterpart emotion signal may be configured to be associated with the selected emotion representation. For example, in a case in which an emotion representation corresponding to joy is selected, a camera may photograph a child, that is, a user of the emotion exchange apparatus 12, with a background having an image related to joy. In a case in which an emotion representation corresponding to happiness is selected, music related to happiness is played, and a voice of the child, that is, the user of the emotion exchange apparatus 12, may be recorded with a background having the music. Through this, the child may learn information associated with the emotion that the child selects, and may improve his or her ability to express his or her emotion.

Further, the counterpart emotion signal may include at least a portion of the emotion signal. For example, in a case in which the emotion signal includes an image, the emotion representation of the counterpart emotion signal described above may be indicated on the image of the emotion signal, and in a case in which the counterpart emotion signal includes an image, the counterpart emotion signal may be indicated in the form of a collage with the image of the emotion signal. Alternatively, the counterpart emotion signal may be generated as the emotion learner conducts doodling on the image of the emotion signal. The emotion learner may express himself or herself by performing doodling on the image transmitted by the emotion deliverer. Such doodling aids in recognizing the emotional state of the child, and the emotion signal and the counterpart emotion signal are connected in a series of signals, leading to one continuous story.

The system server 11 authenticates the emotion exchange apparatus 12, receives a counterpart emotion signal from the emotion exchange apparatus 12, searches for the external device 10 that is registered, and transmits the counterpart emotion signal to the found external device 10 (S34). Through such a process, the emotion exchange apparatus 12 transmits the generated counterpart emotion signal to the external device 10. The system server 11 may separately store the counterpart emotion signal.

The external device 10 receives the counterpart emotion signal and outputs the received counterpart emotion signal (S35). Thereafter, as the above-described processes are repeated, the emotion signal and the counterpart emotion signal are transmitted and received between the external device 10 and the emotion exchange apparatus 12.

Meanwhile, the system server 11 receives the emotion signal from the external device 10 and the counterpart emotion signal from the emotion exchange apparatus 12, processes the received emotion signal and counterpart emotion signal, and manages information about the emotion signal and the counterpart emotion signal. If necessary, the system server 11 may record when the emotion signal is received from the external device 10 and which counterpart emotion signal corresponds to the emotion signal, that is, what type of emotion representation corresponds to the emotion signal.

In addition, the system server 11 may generate a series of signals by combining the emotion signal with the counterpart emotion signal corresponding to the emotion signal in a predetermined method, and store the series of signals (S36). For example, the emotion signal, including a nursery song recorded by parents, and the counterpart emotion signal, including a joy signal generated in response to the emotion signal, may be stored in the form of a set or in series of signals.

In addition, the system server 11 may store a series of signals divided according to the emotion signal or the counterpart emotion signal. For example, the system server 11 may store only bedtime-story-related emotion signals among a plurality of emotion signals and counterpart emotion signals, each of which corresponds to the bedtime-story-related emotion signals. The system server 11 may store a sadness-related counterpart emotion signal and emotion signals, each of which corresponds to the sadness-related counterpart emotion signal, in the form of a set or a series of signals.

In addition, the system server 11 may store the emotion signal and the counterpart emotion signal in a time series order or a sequential order. For example, the system server 11 may store the emotion signal and the counterpart emotion signal from one and two days previous.

The set or the series of signals stored in the system server 11 may be transmitted to the emotion exchange apparatus 12 or the external device 10, and may be received and output by the emotion exchange apparatus 12 (S38) or by the external device 10 (S37). The set or the series of signals arranged by the system server 11 enables the emotion exchange between an emotion deliverer and a child to be stronger and more continual.

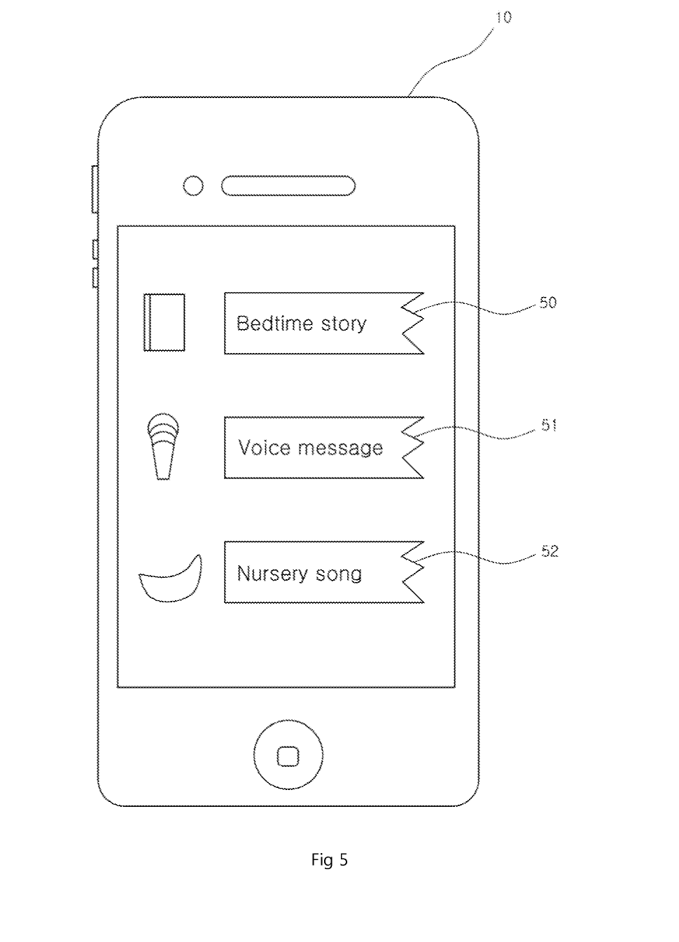

FIG. 4 is a schematic view illustrating the configuration of the emotion exchange apparatus 12 according to an exemplary embodiment of the present invention and a sensor 34 communicating with the emotion exchange apparatus 12. The emotion exchange apparatus 12 may include a speaker, a display device 30, a plurality of buttons 31, a playback or function button 32, and a joystick 35.

As described in the configuration of the emotion exchange apparatus 12 and the flowchart of the emotion exchange apparatus management system 100, the input unit 23 of the emotion exchange apparatus 12 may include the plurality of buttons 31 configured to represent a plurality of emotions. In addition, the input unit 23 may further include the button 32 or the joystick 35 to replay the emotion signal or control the emotion exchange apparatus 12. The emotion exchange apparatus 12 may include a speaker or the display device 30, in a case in which an emotion signal is received, to notify of the reception of the emotion signal and output the emotion signal in an audible or visual manner.

Meanwhile, the sensor 34 communicating with the emotion exchange apparatus 12 is disclosed. The sensor 34 includes a sensor 34 detecting data related to the body of a child, who is a user of the emotion exchange apparatus 12. For example, the sensor 34 may be a sensor 34 detecting blood pressure or a heartbeat. The emotion exchange apparatus 12 may receive information about the blood pressure or the heartbeat from the sensor 34 through a local area network, and may transmit the received information to the external device 10 through a communication network. Meanwhile, as described above in FIG. 3, the external device 10 is an external device registered by the emotion exchange apparatus 12. Accordingly, a user of the external device 10 may be a parent or a family physician, and the parent or the family physician may receive health-related information from the emotion exchange apparatus 12 through the external device 10. That is, the parent or the family physician may obtain continual information about the physical state of a child while simultaneously obtaining and monitoring the emotional and physical information.

Further, the emotion exchange apparatus 12 may receive an instruction from the external device 10 and deliver the received instruction to other devices. For example, a parent or a family physician, based on the health-related information described above, may transmit an instruction about an external environment which may affect the health or emotional state of a child to the emotion exchange apparatus 12 through the external device 10. The parent or the family physician may transmit instructions about the setting on the current temperature of an air conditioner, the brightness or on/off of a lamp, the locking of doors, and the volume or on/off of music to the emotion exchange apparatus 12. The emotion exchange apparatus 12 may transmit the instructions to a nearby device associated with the emotion exchange apparatus 12 according to the instruction. FIG. 5 is a view showing a schematic user interface (UI) of the external device 10 associated with the emotion exchange apparatus 12 according to an exemplary embodiment of the present invention. A smartphone-purpose application, a customized program, and a website, which are provided from the system server 11, may be installed or indicated on the external device 10. According to an exemplary embodiment of the present invention, an emotion deliverer may generate an emotion signal by recording a bedtime story 40, a voice message 41, or a nursery song 42 through the external device 10. In a case in which the bedtime story 41 is selected, sentences of a fairy tale may be displayed on the external device 10, and the emotion deliverer may perform the recording by reading the sentences. In addition, in the middle of performing the recording, a background sound may be inserted. The voice message 41 or the nursery song 42 may be also provided together with related information that may be input in the similar manner to the bedtime story 40.

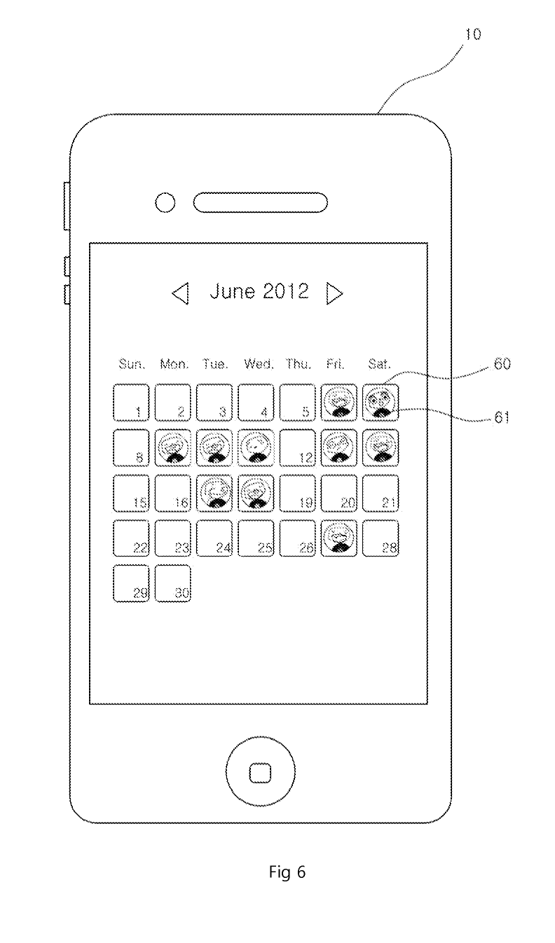

FIG. 6 is a view showing a schematic user interface (UI) related to continual storytelling by the emotion exchange apparatus 12 according to an exemplary embodiment of the present invention. The external device 10 according to an exemplary embodiment of the present invention is configured to display calendar information 50 and a counterpart emotion signal 51 that corresponds to a transmission date. A system server stores a date when an emotion signal received from the external device 10 is transmitted and a date when a counterpart emotion signal received from the emotion exchange apparatus 12 is transmitted. In addition, the system server arranges the counterpart emotion signals in a time series order, and transmits the calendar information 50 to the external device 10. In this manner, the emotion deliverer may manage the date when the emotion deliverer has transmitted the emotion signal, and check what type of counterpart emotion signal 51 has been received in response to each emotion signal, and thereby an organic and continual emotion exchange can be experienced.

Meanwhile, the UI of FIG. 6 is illustrated only as an example, and a display method is not limited thereto in implementing the present invention as long as the display method manages the emotion signal and the counterpart emotion signal at the external device 10 while representing an organic and continual emotion exchange. For example, a display method through the above described classification depending on the emotion signal or the counterpart emotion signal may be possible.

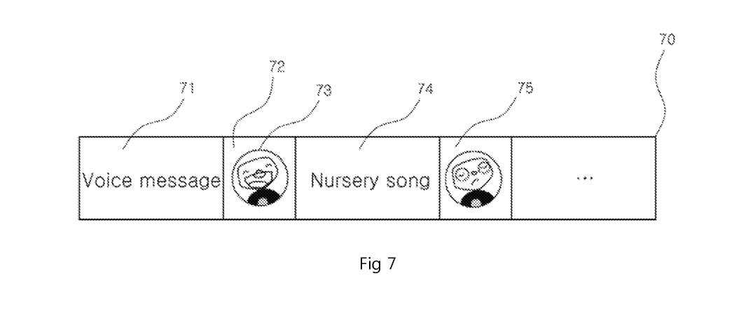

FIG. 7 is a schematic view of a series of signals 60 related to continual storytelling according to an exemplary embodiment of the present invention. The series of signals 60 related to the continual storytelling may be an emotion signal, a counterpart emotion signal, or a combination thereof. According to an exemplary embodiment of the present invention, the series of signals 60 may include a first emotion signal 61, a first counterpart emotion signal 62, a second emotion signal 64, and a second counterpart emotion signal 65. The first emotion signal 61 may be for example a voice message from an emotion deliverer, and the first counterpart emotion signal 62 may be an emotion representation signal 63 of joy. The second emotion signal 64 may be for example a nursery song, and the second counterpart emotion signal 65 may be an emotion representation signal of sadness. The series of signals 60 may be provided to the external device 10 or the emotion exchange apparatus 12 in a visual manner as shown in FIG. 7. In this case, the user may replay each signal by selecting the signal.

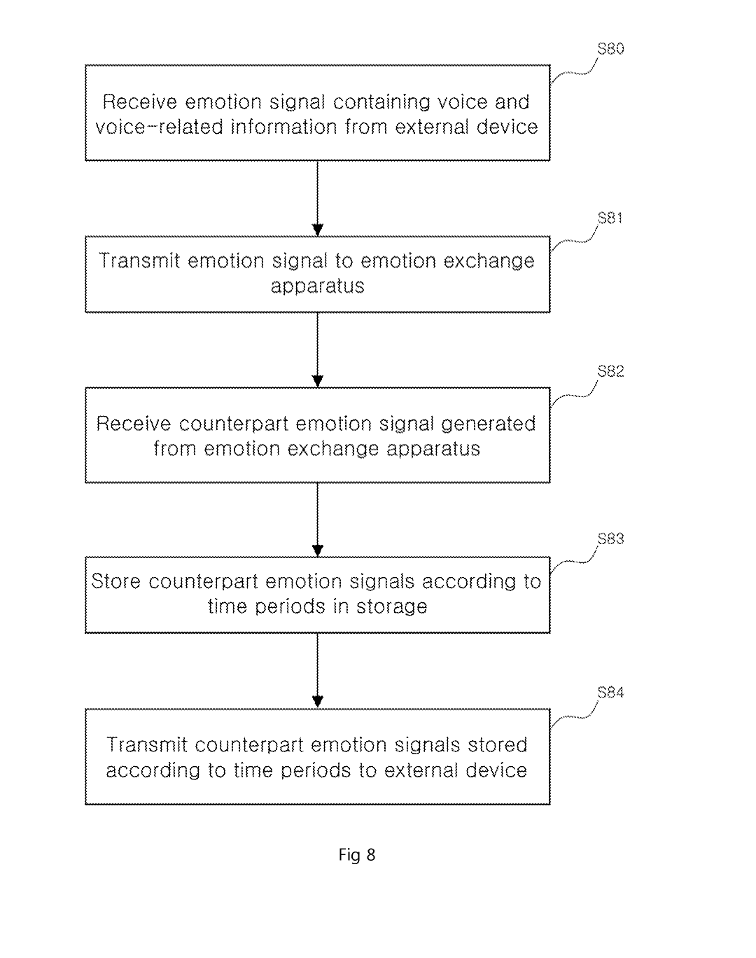

FIG. 8 is a flowchart showing an emotion exchange method at a server end according to an exemplary embodiment of the present invention. A system server receives an emotion signal containing at least a voice and voice-related information from the external device 10 (S81). Thereafter, the system server transmits the emotion signal to the emotion exchange apparatus 12 (S82). The system server receives a counterpart emotion signal generated from the emotion exchange apparatus 12 (S83), and stores the counterpart emotion signal according to time periods in the storage (S84). The system server transmits the counterpart emotion signal stored according to time periods to the external device 10 or the emotion exchange apparatus 12 (S85).

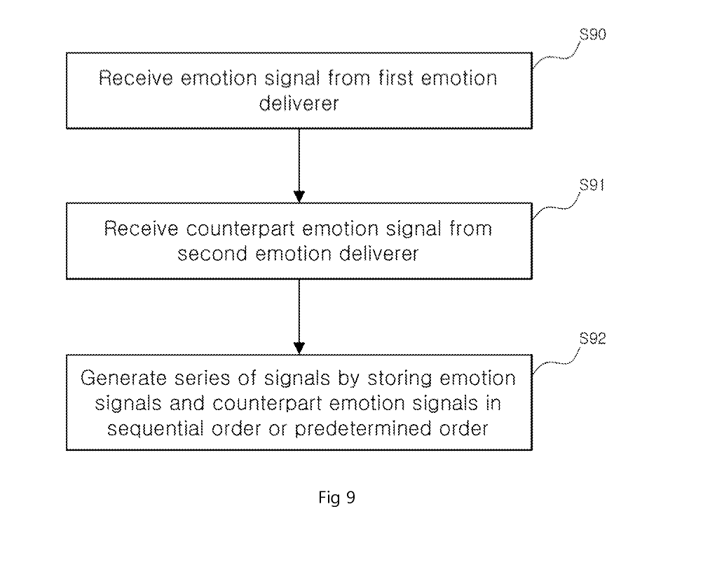

FIG. 9 is a flowchart showing an emotion exchange method according to another exemplary embodiment of the present invention. According to the emotion exchange method of another exemplary embodiment of the present invention, a first emotion deliverer and a second emotion deliverer use the emotion exchange apparatus 12 to exchange emotion. For example, a method in which two or more emotion deliverers input an emotion signal to a single emotion exchange apparatus 12 is provided. For convenience of description, the following description will be made in relation to the emotion exchange apparatus 12.

According to the emotion exchange method according to another exemplary embodiment of the present invention, an emotion signal is input from a first emotion deliverer through the emotion exchange apparatus 12 (S91). The emotion signal may be input in an audible or visual manner through a microphone, a camera, a joystick, buttons, and a touch screen, and may be only a selection of an emotion expression.

A counterpart emotion signal is input from a second emotion deliverer through the emotion exchange apparatus 12 (S92). The counterpart emotion signal may also be input in an audible manner or visual manner through a microphone, a camera, a joystick, buttons, and a touch screen, and may be only a selection of an emotion expression.

The emotion exchange apparatus 12 stores emotion signals and counterpart emotion signals in a sequential order or a predetermined order to generate a series of signals (S93). The series of signals may be output by the emotion exchange apparatus 12 in an audible or visual manner.

That is, the emotion deliverer and the emotion learner may simultaneously generate storytelling through a single emotion exchange apparatus 12. For example, the emotion deliverer selects an emotion using an input unit including a joystick of the emotion exchange apparatus 12, and the emotion learner may select a counterpart emotion using another input unit. In this manner, storytelling including the emotion signal and the counterpart emotion signal may be generated at the emotion exchange apparatus 12 including a plurality of inputs. Through this, mutual two-way communication is achieved. Storytelling or a series of signals formed and recorded is transmitted to another external device, and induces an emotion exchange with another emotion deliverer.

As described above, the emotion exchange apparatus and the method of providing the same according to the present invention can provide a continual emotion exchange between a child and parents, as opposed to the fragmentary education or experience of emotion provided by existing emotion education dolls and learning robots, by providing an emotion exchange between parents and a child in a storytelling method.

In addition, the emotion exchange apparatus and the method of providing the same according to the present invention can enable a child to learn various emotions in a more effective way by expressing emotions through various experience methods. In addition, even if a parent or an educator is not present in the same space with a child, the emotion of the child can be conveyed, and since the emotion exchange is performed through the emotion exchange apparatus, the emotion can be delivered with no spatial limitation.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. An emotion exchange apparatus comprising:
a communication unit configured to receive an emotion signal of an emotion deliverer from an external device;
an output unit configured to output the emotion signal
an input unit configured to receive a counterpart emotion signal of an emotion learner in response to the emotion signal; and
a controller coupled to one or more of the output unit, the input unit, and the communication unit, and configured to receive the emotion signal from the external device through the communication unit, output the emotion signal in an audible or visual manner, receive the counterpart emotion signal from the input unit, and transmit the counterpart emotion signal to the external device through the communication unit.

2. The emotion exchange apparatus of claim 1, wherein the controller indicates reception of the emotion signal through the output unit.

3. The emotion exchange apparatus of claim 1, wherein the emotion signal comprises a voice and information related to the voice, and the output unit simultaneously outputs the voice and the information related to the voice.

4. The emotion exchange apparatus of claim 3, wherein the information related to the voice is a fairy tale, a nursery song, or information related to delivering emotion.

5. The emotion exchange apparatus of claim 1, wherein the controller outputs the emotion signal or the counterpart emotion signal in an arrangement form according to a predetermined scheme.

6. The emotion exchange apparatus of claim 1, wherein the controller receives data related to a human body from an external sensor, and transmits the data related to the human body to the external device through the communication unit.

7. The emotion exchange apparatus of claim 1, wherein the counterpart emotion signal is generated by selecting one of a plurality of emotion representations on the input unit.

8. The emotion exchange apparatus of claim 1, wherein the counterpart emotion signal comprises information related to an emotion representation or at least one portion of the emotion signal.

9. The emotion exchange apparatus of claim 1, wherein the input unit comprises at least one of buttons, a touch panel, a joystick, a microphone, a camera, a keyboard, and a mouse.

10. A method of providing emotion exchange, the method comprising:
receiving an emotion signal comprising at least a voice and information related to the voice from an external device;
transmitting the emotion signal to an emotion exchange apparatus;
receiving a counterpart emotion signal generated from the emotion exchange apparatus;
storing the counterpart emotion signal in a storage according to time periods; and
transmitting the counterpart emotion signal stored according to time periods to the external device or the emotion exchange apparatus.

11. The method of claim 10, wherein the information related to the voice is a fairy tale, a nursery song, or information related to delivering emotion.

12. The method of claim 10, further comprising receiving data related to a human body from the emotion exchange apparatus, and transmitting the data related to the human body to the external device.

13. The method of claim 10, wherein the counterpart emotion signal is generated by selecting one of a plurality of emotion representations on the emotion exchange apparatus.

14. A method of exchanging emotion through an emotion exchange apparatus, the method comprising:
receiving an emotion signal from an emotion deliverer;
receiving a counterpart emotion signal from an emotion learner; and
generating a series of signals by storing the emotion signal and the counterpart emotion signal in a sequential order or a predetermined order.

15. The method of claim 14, wherein the emotion signal is a fairy tale, a nursery song, or information related to delivering emotion.

16. The method of claim 14, wherein the emotion signal or the counterpart emotion signal is generated by selecting one of a plurality of emotion representations on the emotion exchange apparatus.
